(19) United States
(12) Patent Application Publication
(10) Pub. No.: US 2005/0002450 A1
(43) Pub. Date: Jan. 6, 2005

(54) Frequency difference measuring method

(75) Inventor: Young Jae Kim, Anyang (KR)

Correspondence Address: FLESHNER & KIM, LLP, P. O. Box 221200, Chantily, VA, 20153-1200, US

(73) Assignee: LG ELECTRONICS INC.

(21) Appl. No.: 10/879,204

(22) Filed: Jun. 30, 2004

(30) Foreign Application Priority Data
Jul. 4, 2003 (KR) 45342/2003

(51) Int. Cl. H04B 3/46

(52) U.S. Cl. 375/224

(57) ABSTRACT

A method for measuring a frequency difference in a TDD (Time Division Duplex) based mobile communication system is disclosed. The frequency difference measuring method includes calculating phase change values of a demodulated signal based on a predetermined sample interval, and determining an average frequency difference value between a transmission frequency and a reception frequency on the basis of the calculated phase change values.

The present application claims priority from Korean Patent Application No. 45342/2003, filed on Jul. 4, 2003, the subject matter of which is incorporated herein by reference.

### BACKGROUND OF THE INVENTION

1. Field of the Invention

The present invention relates to a mobile communication system and, more particularly, to a frequency difference measuring method in a mobile communication system of a TDD (Time Division Duplex).

2. Description of the Related Art

Generally, in a mobile communication system, a sending side transmits and a receiving side receives a signal at a predetermined frequency generated through a frequency generator. The frequency of the transmitted/received signal is not identical to the predetermined frequency due to changes in characteristics of the frequency generator according to environmental factors and Doppler effect from movement of a mobile communication terminal.

Thus, the receiving side of the mobile communication system needs to receive the signal by minimizing a difference between transmission frequency and reception frequency, in order to prevent degradation of performance of the mobile communication system.

### SUMMARY OF THE INVENTION

An object of the invention is to solve at least the above problems and/or disadvantages and to provide at least the advantages described hereinafter.

Another object of the present invention is to provide a frequency difference measuring method and apparatus capable of accurately measuring an average frequency difference value between a transmission frequency and a reception frequency based on phase change values by calculating the phase change values on the basis of a predetermined sample interval.

To achieve at least these objects and other advantages in a whole or in part and in accordance with the purpose of the present invention, as embodied and broadly described herein, there is provided a frequency difference measuring method including comprising, calculating a phase change value of a demodulated signal on the basis of a predetermined sample interval; and determining an average frequency difference value between a transmission frequency and a reception frequency on the basis of the calculated phase change value. To achieve at least these objects and other advantages and in accordance with the purpose of the present invention, as embodied and broadly described herein, there is also provided a frequency difference measuring method in a mobile communication system for determining a difference value between a transmission frequency and a reception frequency, comprising, demodulating a receiving signal, extracting a phase component of the demodulated signal, calculating a phase change value of the extracted phase component on the basis of a predetermined sample interval, measuring a frequency difference value corresponding to the calculated phase change value, and averaging measured frequency difference values and determining an obtained average value as an average frequency difference value between the transmission frequency and the reception frequency.

To achieve at least these objects and other advantages and in accordance with the purpose of the present invention, as embodied and broadly described herein, there is also provided a mobile communication system including, a demodulator for receiving an input signal and outputting a demodulated signal, and a frequency difference measuring unit for calculating phase change values of the demodulated signal on the basis of a predetermined sample interval, and determining an average frequency difference value between a transmission frequency and a reception frequency based on the calculated phase change.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a schematic block diagram of a general frequency difference measuring apparatus having an AFC (Automatic Frequency Control) structure;

FIG. 2 is a graph showing a phase change of a demodulated signal;

FIG. 3 is a graph showing a principle of calculating a phase change value;

FIG. 4 is a flow chart of a frequency difference measuring method in accordance with an embodiment of the present invention; and

FIG. 5 is a graph showing a principle of calculating a phase change value in accordance with an embodiment of the present invention.

### DETAILED DESCRIPTION OF THE PREFERRED EMBODIMENTS

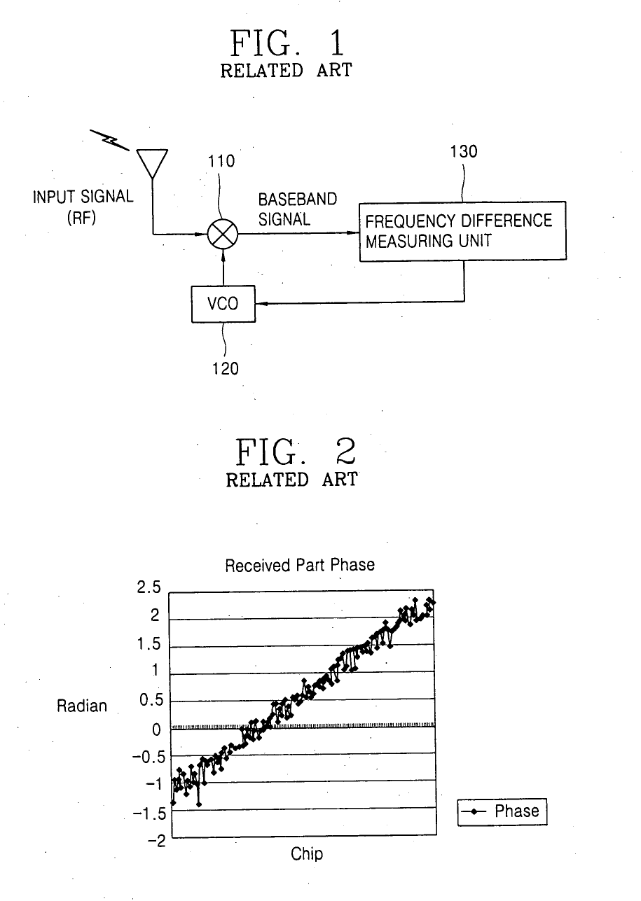

FIG. 1 is a block diagram showing a general frequency difference measuring apparatus of an AFC (Automatic Frequency Control) structure.

As shown in FIG. 1, the frequency difference measuring apparatus includes a demodulator 110 for demodulating a signal received through an antenna on the basis of an oscillation frequency and outputting a baseband signal; a frequency generator 120 for generating the oscillation frequency inputted to the demodulator 110; and a frequency difference measuring unit 130 for calculating a difference between a frequency of the signal inputted from the demodulator 110 and the oscillation frequency. Preferably, the frequency generator 120 is constructed as a VCO (Voltage Control Oscillator). However, the present invention is not intended to be so limited.

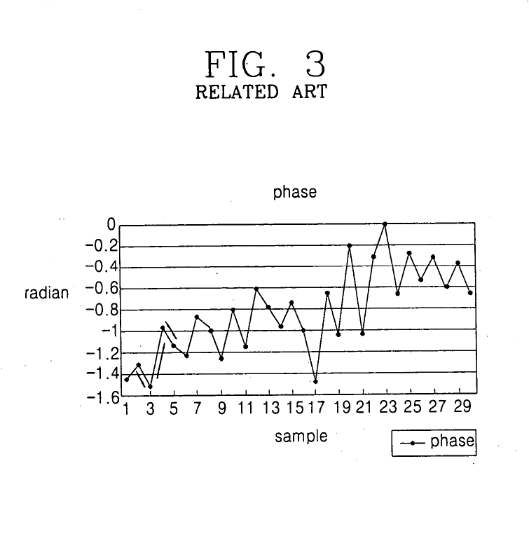

A frequency difference measuring method of the apparatus constructed as described above will now be described with reference to FIGS. 2 and 3.

The sending side carries and transmits data s(t) on a transmission frequency fₜ, and the receiving side demodulates the received signal by using the reception frequency fᵣ. A difference value between the transmission frequency fₜ and the reception frequency fᵣ can be defined by equation (1) shown below:
f_{d}=fₜ−fᵣ (1)

In this case, when the transmission frequency fₜ and the reception frequency fᵣ are identical to each other, the receiving side can successfully receive the data s(t).

If, however, the transmission frequency fₜ and the reception frequency fᵣ are not identical, the receiving side would receive data s(t)·e^{jπf}^{_{d}}^{t}, not s(t).

Thus, when the sending side and the receiving side use a well-known signal such as a pilot signal as the data s(t), the receiving side can calculate a phase change value of e^{j2πf}^{_{d}}^{t} of the demodulated signal and measure a difference value f_{d} between the transmission frequency fₜ and the reception frequency fᵣ on the basis of the obtained phase change value.

First, the receiving side extracts a phase component without the data s(t) from the demodulated signal as expressed in equation (2) shown below:
i(tₙ)=e^{j2πf}^{_{d}}^{ₙ}, herein n=1, 2, . . . , N (2)

The phase change of the phase component will now be described, with reference to FIG. 2, which shows a graph of a phase change of a demodulated signal.

As shown in FIG. 2, the phase value 2πf_{d}t of e^{i2πf}^{_{d}}^{t} of the demodulated signals are displayed roughly linearly according to a time axis. The receiving side can measure the difference value f_{d} between the transmission frequency fₜ and the reception frequency fᵣ on the basis of the phase change values of the phase component. The principle of calculating the phase change values of the phase component will now be described with reference to FIG. 3.

FIG. 3 is a graph showing a principle of calculating phase change. As shown in FIG. 3, phase change values are calculated among mutually adjacent signals by equation (3) shown below:
r(tₙ)·i*(tₙ₊₁)·i*(tₙ₊₁)=e^{j2πf}^{_{d}}^{t}ₙ·e^{-j2πf}^{_{d}}^{t}ₙ=e^{j2πf}^{_{d}}^{t}ₙ·e^{-j2πf}^{_{d}}^{(t}^{ₙ}⁺¹⁾=e^{-j2πf}^{_{d}} (3)

A frequency difference value is obtained on the basis of the calculated phase change value by equation (4) shown below:

$${f}_{dn} = \frac{1}{2 π} {tan}^{- 1} ( \frac{imag ( r ( {t}_{n} ) )}{real ( r ( {t}_{n} ) )} ) \qquad ( 4 )$$

Accordingly, because the N number of frequency difference values are measured on the basis of equation (4), the receiving side averages the measured N number of frequency difference values as shown in equation (5) below, whereby the average value is measured as an average frequency difference value between the transmission frequency and the reception frequency:

$${F}_{d} = \frac{1}{N} {\sum }_{n = 0}^{N} {f}_{dn} \qquad ( 5 )$$

In the frequency difference measuring method, the average frequency difference value between the transmission frequency and the reception frequency is based on the first and the last frequency difference values among the measured N number of frequency difference values.

This can be simplified by equation. For example, the N number of phase values for measuring the average difference value can be expressed as shown below:
Θ₀=2πf_{d}t₀, Θ₁=2πf_{d}t₁, Θ₂=2πf_{d}t₂, . . . , Θ_{N}=2πf_{d}t_{N} (6)

A phase difference between mutually adjacent signals among the phase values can also be expressed as shown below:

$$\begin{matrix}{Φ}_{0} - {Φ}_{1} = 2 π {f}_{d} {t}_{0} - 2 π {f}_{d} {t}_{1} \\ {Φ}_{1} - {Φ}_{2} = 2 π {f}_{d} {t}_{1} - 2 π {f}_{d} {t}_{2} \\ {Φ}_{2} - {Φ}_{3} = 2 π {f}_{d} {t}_{2} - 2 π {f}_{d} {t}_{3} \\ … … … \\ {Φ}_{N - 1} - {Φ}_{N} = 2 π {f}_{d} {t}_{N - 1} - 2 π {f}_{d} {t}_{N}\end{matrix} \qquad ( 7 )$$

In this case, the sum of the calculated phase change values can be expressed by equation (8) shown below:
(Θ₀−Θ₁)+(Θ₁−Θ₂)+(Θ₂−Θ₃)+ . . . +(Θ_{N-1}−Θ_{N})=Θ₀−Θ_{N} (8)

Thus, the receiving side averages the result of equation (8) as shown in equation (9) shown below, whereby the average value can be determined as an average frequency difference value between the transmission frequency and the reception frequency:

$$\frac{{Φ}_{0} - {Φ}_{N}}{N} = \frac{2 π {f}_{d} ( {t}_{0} - {t}_{N} )}{N} \qquad ( 9 )$$

However, since the intermediate phase values are removed during the process of averaging the phase change values and the average frequency difference value between the transmission frequency and the reception frequency is determined on the basis of only the first and last phase values, the determined average frequency difference value is not as accurate as desired.

A frequency difference measuring method capable of more accurately measuring an average frequency value between a transmission frequency and a reception frequency based on phase change value by calculating the phase change value on the basis of a predetermined sample interval, in accordance with a preferred embodiment of the present invention, will now be described with reference to the accompanying drawings.

In general, in a mobile communication system of an FDD (Frequency Division Duplex) method, an uplink frequency and a downlink frequency that is different than the uplink frequency are used for communication. When a specific channel of a downlink is used, a base station can transmit a well-known signal to a terminal. In this condition, the terminal can measure a frequency difference by using a sufficient amount of signal at any time. For example, in a W-CDMA (Wideband-Code Division Multiple Access) system using the FDD method, the mobile communication system can use a CPICH (Common Pilot Channel). The CPICH is a channel through which the base station transmits a signal to the terminal.

Accordingly, when the terminal uses the CPICH to measure the frequency difference, it can use a signal having a high SNR (Signal to Noise Ratio) according to a spreading gain, or can use 150 symbols (=38400 chips) for 10 ms.

Additionally, in a mobile communication system of a TDD (Time Division Duplex) method, transmission time of the uplink and the downlink is divided for communication. That is, since the downlink is not allowed during the uplink time, time is limited for the base station to transmit the well-known signal to the terminal. For example, in a mobile communication system of TD-SCDMA (ime Division-Synchronous CDMA) method using TDD, because the available time for using the downlink is limited, the mobile communication system can use only a midamble signal transmitted when a traffic channel is connected. However, when a 12.2 kbps channel is used, the rate taken up by the midamble signal is merely 2.11% (144 chips among 6800 chips for 5 ms) and only a signal having a low SNR should be used.

Thus, a method and apparatus for accurately measuring a frequency difference value is required for a TD-SCDMA mobile communication system, which uses a relatively low quality and small amount of signal.

Embodiments of a method for accurately measuring a frequency difference between the transmission frequency and a reception frequency in the TDD-based mobile communication will now be described.

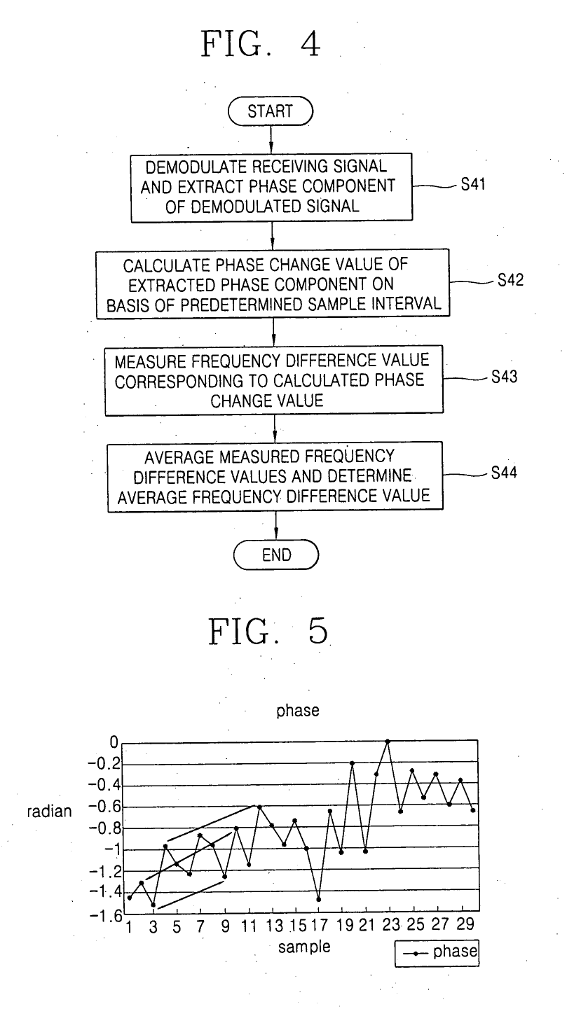

FIG. 4 is a flow chart showing an embodiment of a frequency difference measuring method, in accordance with the present invention. As shown in FIG. 4, the frequency difference measuring method includes demodulating a received signal and extracting a phase component of the demodulated signal (S41); calculating a phase change value of the extracted phase component on the basis of a predetermined sample interval (S42), measuring a frequency change value corresponding to the calculated phase change value (S43), and averaging the measured frequency change values and determining an average value as an average frequency difference value between a transmission frequency and a reception frequency (S44).

The frequency difference measuring method will now be described in additional detail. First, a receiving side extracts a phase component from the demodulated signal with data s(t) having been removed, as expressed in equation (10) shown below (S41):
i(tₙ)=e^{j2πf}^{_{d}}t^{ₙ}, herein n=1, 2, . . . , N (10)

FIG. 5 is a graph showing a principle of calculating a phase change value of the extracted phase component in accordance with one embodiment of the present invention. As shown in FIG. 5, a phase change value expressed in equation (11) shown below is calculated between phase components having a predetermined sample interval (S42):
r(tₙ)=i(tₙ)·i*(tₙ₊ₖ)=e^{j2πf}^{_{d}}^{t}ₙ·e^{-j2πf}^{_{d}}^{t}^{ₙ₊ₗ}=e^{j2πf}^{_{d}}^{(t}^{ₙ}^{+k)}=e^{-j2πkf}^{_{d}} (11)

A frequency difference value is measured using the calculated phase change value by equation (12) shown below (S43):

$${f}_{dn} = \frac{1}{2 π k} {tan}^{- 1} ( \frac{imag ( r ( {t}_{n} ) )}{real ( r ( {t}_{n} ) )} ) \qquad ( 12 )$$

Accordingly, the N number of frequency difference values are measured on the basis of the measured frequency difference value, so that the receiving side averages the measured N number of frequency difference values and determines the obtained average value as an average frequency difference value between the transmission frequency and the reception frequency as expressed in equation (13) shown below (S44):

$${F}_{d} = \frac{1}{N - k} {\sum }_{n = 0}^{N - k} {f}_{dn} \qquad ( 13 )$$

In this manner, the frequency difference measuring method can measure the average frequency difference between the transmission frequency and the reception frequency on the basis of the phase change value between phase components distanced as long as or longer than the predetermined sample interval. For example, the N number of phase values for measuring the average frequency difference value can be expressed by equation (14) as shown below:
Θ₀=2πf_{d}t₀, Θ₁=2πf_{d}t₁, Θ₂=2πf_{d}t₂, . . . , Θ_{N}=2πf_{d}t_{N} (14)

The phase difference value between phase components distanced as long as or longer than the predetermined sample interval can be expressed by equation (15) as shown below:

$$\begin{matrix}{Φ}_{0} - {Φ}_{k} = 2 π {f}_{d} {t}_{0} - 2 π {f}_{d} {t}_{k} \\ {Φ}_{1} - {Φ}_{k + 1} = 2 π {f}_{d} {t}_{1} - 2 π {f}_{d} {t}_{k + 1} \\ {Φ}_{2} - {Φ}_{k + 2} = 2 π {f}_{d} {t}_{2} - 2 π {f}_{d} {t}_{k + 2} \\ … … … \\ {Φ}_{N - k - 2} - {Φ}_{N - 2} = 2 π {f}_{d} {t}_{N - k - 2} - 2 π {f}_{d} {t}_{N - 2} \\ {Φ}_{N - k - 1} - {Φ}_{N - 1} = 2 π {f}_{d} {t}_{N - k - 1} - 2 π {f}_{d} {t}_{N - 1} \\ {Φ}_{N - k} - {Φ}_{N} = 2 π {f}_{d} {t}_{N - k} - 2 π {f}_{d} {t}_{N}\end{matrix} \qquad ( 15 )$$

The sum of the calculated phase change values is expressed by equation (16) shown below:

$$( {Φ}_{0} - {Φ}_{k} ) + ( {Φ}_{1} - {Φ}_{k + 1} ) + ( {Φ}_{2} - {Φ}_{k + 2} ) + … + ( {Φ}_{k - 1} - {Φ}_{2 k - 1} ) + ( {Φ}_{k} - {Φ}_{2 k} ) + ( {Φ}_{k + 1} - {Φ}_{2 k + 1} ) + … + ( {Φ}_{N - 2 k} - {Φ}_{N - k} ) + ( {Φ}_{N - 2 k + 1} - {Φ}_{N - k + 1} ) + … + ( {Φ}_{N - k - 1} - {Φ}_{N - 1} ) + ( {Φ}_{N - k} - {Φ}_{N} ) = {\sum }_{n = 0}^{k - 1} {Φ}_{n} - {\sum }_{i = N - k + 1}^{N} {Φ}_{i} \qquad ( 16 )$$

Accordingly, the receiving side can determine the average frequency difference value between the transmission frequency and the reception frequency by averaging the result of equation (16). At this time, because the receiving side can use the phase values that may be as many as k at the (+) item and as many as k at the (−) item, according to the ‘k’ value of equation (16), the receiving side can determine a relatively accurate frequency difference value.

As described above, the frequency difference measuring method and apparatus according to the present invention has at least the following advantage.

For example, a phase change value is calculated on the basis of a predetermined sample interval, based on which a frequency difference value between a transmission frequency and a reception frequency is accurately determined. Thus, a receiving side can accurately receive data from a sending side, so that a performance of the mobile communication system can be improved.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

1. A frequency difference measuring method, comprising:
calculating phase change values of a demodulated signal on the basis of a predetermined sample interval; and
determining an average frequency difference value between a transmission frequency and a reception frequency on the basis of the calculated phase change values.

2. The method of claim 1, wherein the predetermined sample interval corresponds to the number of calculated phase change values.

3. The method of claim 2, wherein, no sample is repeated for the predetermined sample interval.

4. The method of claim 1, wherein the average frequency difference value is determined by averaging frequency difference values corresponding to the calculated phase change values and determining an obtained average value as an average frequency difference value between the transmission frequency and the reception frequency.

5. A frequency difference measuring method in a mobile communication system for determining a difference value between a transmission frequency and a reception frequency, comprising:
demodulating a receiving signal;
extracting a phase component of the demodulated signal;
calculating phase change values of the extracted phase component on the basis of a predetermined sample interval;
measuring frequency difference values corresponding to the calculated phase change values; and
averaging the measured frequency difference values and determining an obtained average value as an average frequency difference value between the transmission frequency and the reception frequency.

6. The method of claim 5, wherein the predetermined sample interval corresponds to the number of phase change values to be extracted.

7. The method of claim 6, wherein no sample is repeated for the predetermined sample interval.

8. The method of claim 5, wherein the extracted phase component is extracted from the demodulated receiving signal with data s(t) having been removed, and wherein the extracted phase component is expressed as:
i(tₙ)=e^{j2πf}^{_{d}}^{t}^{ₙ}
wherein n=1, 2, . . . , N, with N being a number of frequency difference values, and fd being the difference value.

9. The method of claim 5, wherein each calculated phase change value is expressed as:
r(tₙ)=e^{-j2πf}^{_{d}}
wherein n=1, 2, . . . , N, with N being a number of frequency difference values, f_{d} is the difference value and k is a constant value.

10. The method of claim 9, wherein the frequency difference value is expressed as:
$${f}_{dn} = \frac{1}{2 π} {tan}^{- 1} ( \frac{imag ( r ( {t}_{n} ) )}{real ( r ( {t}_{n} ) )} ) .$$

11. The method of claim 10, wherein the averaged measured frequency difference values is expressed as:
$${F}_{d} = \frac{1}{N} {\sum }_{n = 0}^{N} {f}_{dn} .$$

12. The method of claim 5, wherein the average frequency difference value between the transmission frequency and the reception frequency is determined based on a phase change value between phase components distanced at least as long as the predetermined sample interval.

13. A mobile communication system, comprising:
a demodulator for receiving a modulated input signal and outputting a demodulated signal; and
a frequency difference measuring unit for calculating phase change values of the demodulated signal on the basis of a predetermined sample interval, and determining an average frequency difference value between a transmission frequency and a reception frequency based on the calculated phase change.
